(19) United States
(12) Patent Application Publication
(10) Pub. No.: US 2022/0357176 A1
(43) Pub. Date: Nov. 10, 2022

(54) METHODS AND DATA PROCESSING SYSTEMS FOR PREDICTING ROAD ATTRIBUTES

(71) Applicant: GRABTAXI HOLDINGS PTE. LTD., Singapore (SG)

(72) Inventors: Yifang YIN, Singapore (SG); Jagannadan VARADARAJAN, Singapore (SG); Guanfeng WANG, Singapore (SG); Roger ZIMMERMANN, Singapore (SG)

(21) Appl. No.: 17/611,115

(22) PCT Filed: Jan. 31, 2020
(86) PCT No.: PCT/SG2020/050046

§ 371 Date: Nov. 12, 2021

(51) Int. Cl. G01C 21/00; G06N 5/02

(52) U.S. Cl. CPC G01C 21/3804; G06N 5/022

(57) ABSTRACT

The disclosure relates to a method of predicting one or more road attributes. The method may include providing trajectory data of a geographical area. The method may further include providing map data, wherein the map data may include image data of the geographical area. The method may further include extracting trajectory features from the trajectory data and extracting map features from the map data. The method may further include using at least one processor to predict road attributes by inputting the trajectory features and the map features in a neural network and by classifying an output of the neural network into prediction probabilities of the road attributes. The disclosure also relates to a data processing system; to a non-transitory computer-readable medium storing computer executable code; and to a method of training an automated predictor.

### TECHNICAL FIELD

Various embodiments relate to a method of predicting road attributes for creating or updating a digital map for a geographical area; a data processing system configured to carry out the method; computer executable code comprising instructions for extracting road attributes; a non-transitory computer-readable medium storing the same; and a method for training an automated predictor of road attributes.

### BACKGROUND

The service of ride-hailing providers significantly relies on the quality of a digital map. Incomplete map data such as a missing road or even a missing road attribute can lead to misleading routing decisions or inaccurate prediction of a driver's arrival time. However, the updating of both commercial and free maps still heavily relies on the manual annotations from human. The high cost results in maps with low completeness and inaccurate outdated data. Taking the OpenStreetMap (OSM) as an example, which provides the community a user-generated map of the world, its data completeness and accuracy vary significantly in different cities. For example, in Singapore, while most of the roads are annotated in the map with the one-way or two-way tags, only about 40% and 9% of the roads are annotated with the number of lanes and the speed limit in the downtown area.

Therefore, current methods of updating map data have drawbacks and it is desired to provide for an improved method of updating map data.

### SUMMARY

The disclosure relates to a method of predicting one or more road attributes, a data processing system, a non-transitory computer-readable medium storing computer executable code for carrying out the method, a computer executable code, and a method for training an automated predictor.

A first aspect of the disclosure relates to a method of predicting one or more road attributes corresponding to roads in a geographical area. For example, for creating or updating a map and/or a vehicle routing decision database for the geographical area. The geographical area includes road segments. The method may include providing trajectory data of the geographical area. The method may further include providing map data, wherein the map data may include image data of the geographical area. The method may further include extracting trajectory features from the trajectory data. The method may further include extracting map features from the map data. The method may further include using at least one processor to predict road attributes by inputting the trajectory features and the map features in a neural network and by classifying an output of the neural network into prediction probabilities of the road attributes. The neural network and the classifier may be included in a classifier logic. The classifier logic may be a trained classifier logic.

A second aspect of the disclosure relates to a data processing system. The data processing system may include one or more processors. The data processing system and/or the processors may be configured to carry out the method of predicting road attributes.

A third aspect of the disclosure relates to a non-transitory computer-readable medium storing computer executable code including instructions for extracting road attributes according to the method of predicting one or more road attributes in accordance with various embodiments.

A fourth aspect of the disclosure relates to a computer executable code including instructions for extracting road attributes according to the method of predicting one or more road attributes in accordance with various embodiments.

A fifth aspect of the disclosure relates to a computer program-product configured to carry out instructions for extracting road attributes according to the method of predicting one or more road attributes in accordance with various embodiments.

A sixth aspect of the disclosure relates to a method for training an automated predictor. The automated predictor may be included in the data processing system in accordance with various embodiments. The method for training may include performing forward propagation by inputting training data into an automated predictor to obtain an output result, for a plurality of road segments of a geographical area. The training data may include trajectory features. The training data may further include map features having an electronic image format. The method for training may include performing back propagation according to a difference between the output result and an expected result to adjust weights of the automated predictor. The difference may be calculated as a loss, using a loss function. The method for training may include repeating the above steps of performing forward and back propagation until a pre-determined convergence threshold is achieved. The automated predictor may include a neural network configured to predict road attributes based on trajectory features and map features. The automated predictor may include a classifier configured to classify an output of the neural network into prediction probabilities of the road attributes.

A seventh aspect of the disclosure relates to a trained automated predictor and, a trained automated predictor including the automated predictor, trained by the method for training in accordance with various embodiments.

### BRIEF DESCRIPTION OF THE DRAWINGS

The invention will be better understood with reference to the detailed description when considered in conjunction with the non-limiting examples and the accompanying drawings, in which:

FIG. 1 shows a partial representation of a geographical area 10 including map data 120 in the form of image data (122). In the representation, trajectory data 110 is overlaid on the map data (122);

FIG. 2 shows a cropped image 123 centered on a road segment 22;

FIG. 3 shows a schematic representation of a data processing system 3000 including data extraction, neural network processing by a neural network 300, and classification by a classifier 400, for generating prediction probabilities 500;

FIG. 4 shows a schematic representation of a routing request and decision system 4000;

FIG. 5 shows a schematic representation of a portion of the neural network 300, including a first sub-neural network 311 which outputs shared global trajectory features 316 which are fused with attention scores α^{x}.

FIG. 6 shows a schematic representation of a portion of the neural network 300, including a second sub-neural network 321 which outputs shared global map features 326 which are fused with attention scores α^{v};

FIG. 7 shows schematic representations of (a) the architecture of the first sub-neural network 311, and (b) the architecture of the second sub-neural network 322; and

FIG. 8 shows the architecture of an exemplary computer 8000 which may be used to implement any system in accordance with various embodiments, or any method in accordance with various embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the methods for predicting, systems, computer executable codes, non-transitory computer-readable medium, and methods for training, are analogously valid for the other methods for predicting, systems, computer executable codes, non-transitory computer-readable medium, and methods for training. Similarly, embodiments described in the context of a method for predicting are analogously valid for a system, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

The terms “first” and “second” may be used herein to distinguish between elements or method steps, and have no other limitation, for example, a “second” element or method step may be provided without the requirement of a “first” element or method being provided.

The term “road” as used herein may mean a way which is envisaged for a vehicle locomotion, and its meaning may include motorway (also known as highway), main road, street, or a combination thereof.

The term “vehicle” may mean a motor vehicle, for example a car, or a bus.

The term “bearing” as used herein may mean the vehicle's moving direction, for example with respect to a reference. For example, bearing of a vehicle may be the clock-wise angle of the vehicle moving direction with respect to the earth's true north direction.

The term “neural network” as used herein may mean an artificial neural network, for example an electronic neural network, such as a digital neural network. A neural network may be implemented on a computer. The skilled person in the art would understand, based on the present disclosure, that, in embodiments and examples not related to training, the neural network is a trained neural network, the classifier is a trained classifier, and the automated predictor is a trained automated predictor. For example, an automated predictor may have been trained based on a training data record including training vehicle trajectory data of at least one sub-area of the geographical area, the vehicle trajectory data including location, bearing and speed, and map data (i.e., training images) of the at least one sub-area of the geographical area, wherein the training vehicle trajectory data or the training images include the one or more road attributes. Since the automated predictor includes the neural network and the classifier, these are trained together.

According to various embodiments, the neural network may be configured to receive the trajectory features and the map features and to generate task-specific fused representations. The classifying may be executed by a classifier, and the classifier may be configured to calculate one or more of the prediction probabilities based on the task-specific fused representations.

According to various embodiments, the trajectory features may be processed by a first sub-neural network into shared global trajectory features, wherein the first sub-neural network may include one or more fully-connected layers.

According to various embodiments, the method may further include determining attention scores of pre-defined indicators corresponding to road attributes based on the trajectory data. The pre-defined indicators may be processed by a fully connected layer. The attention scores may be determined based on activation functions.

According to various embodiments, the map features may be processed by a second sub-neural network into shared global map features.

According to various embodiments, the pre-defined indicators may be processed by a fully connected layer. According to various embodiments, the attention scores are determined based on activation functions.

According to various embodiments, the task-specific fused representations may be calculated based on the fusion of the attention scores with the shared global trajectory features of the first sub-neural network. Respective trajectory task-specific weighted representations may be provided by the fusion of the attention scores with the shared global trajectory features of the first sub-neural network.

According to various embodiments, the task-specific fused representations may be calculated based on the fusion of the attention scores with the shared global map features of the second sub-neural network. Respective map task-specific weighted representations may be provided by the fusion of the attention scores with the shared global map features of the second sub-neural network. According to various embodiments, the task-specific fused representations may be determined based on the map task-specific weighted representations and the trajectory task-specific weighted representations, for example, it may be calculated by fusing the map task-specific weighted representations with the trajectory task-specific weighted representations.

According to various embodiments, extracting map features from the map data may include generating cropped images by cropping images from the image data. The cropped images may be centered at a corresponding road segment of the road segments.

According to various embodiments, extracting trajectory features from the trajectory data may include determining group of traces of the trajectory data that are associated with a road segment of the road segments.

According to various embodiments, extracting trajectory features from the trajectory data may further include calculating respective distributions of one or more location, bearing, and speed, and using the respective distributions as the trajectory features.

According to various embodiments, the trajectory data may include a plurality of data points, wherein each data point may include latitude, longitude, bearing, and speed.

According to various embodiments, the data processing system may include a first memory configured to store trajectory data of the geographical area. The data processing system may include a second memory configured to store map data. The map data may include image data of the geographical area.

According to various embodiments, the data processing system may include a trajectory feature extractor configured to extract trajectory features from the trajectory data. The data processing system may include a map feature extractor configured to extract map features from the map data. The data processing system may include a neural network configured to predict road attributes based on trajectory features and map features. The data processing system may include a classifier configured to classify an output of the neural network into prediction probabilities of the road attributes. The neural network and the classifier may be included in a classifier logic. The classifier logic may be a trained classifier logic.

According to various embodiments, the neural network may be configured to receive the trajectory features and the map features and to generate task-specific fused representations. The classifier may be configured to calculate one or more of the prediction probabilities based on the task-specific fused representations.

According to various embodiments, the neural network may include a first sub-neural network configured to process the trajectory features into shared global trajectory features. The first sub-neural network may include one or more fully-connected layers.

According to various embodiments, the neural network may include a first sub-neural network configured to process the trajectory features into shared global trajectory features. The first sub-neural network may include one or more fully-connected layers.

According to various embodiments, the neural network may be further configured to determine attention scores of pre-defined indicators associated with road attributes based on the trajectory data. The neural network may further include a fully connected layer and the pre-defined indicators may be processed by the fully connected layer. The attention scores may be determined based on activation functions, for example, a sigmoid.

According to various embodiments, the neural network may be configured to fuse the attention scores with the shared global trajectory features of the first sub-neural network thereby generating trajectory task-specific weighted representations.

According to various embodiments, the neural network may further include a second sub-neural network configured to transform the map features into a shared global map features.

According to various embodiments, the neural network may be further configured to determine attention scores of pre-defined indicators based on map features. The neural network may further include a fully connected layer and the pre-defined indicators may be processed by the fully connected layer. The attention scores may be determined based on activation functions, for example, a sigmoid. According to various embodiments, the neural network may be configured to fuse the attention scores with the shared global map features of the second sub-neural network when generating map task-specific weighted representations.

According to various embodiments, the neural network may be configured provide task-specific fused representations by fusing the respective trajectory task-specific weighted representations with the respective map task-specific weighted representations.

### Extraction of Trajectory Features

The method of predicting one or more road attributes may include a step of providing vehicle trajectory data.

As used herein, and in accordance with various embodiments, trajectory data may include geographical data, such as geospatial coordinate and may further include time, for example, as provided by the global positioning system GPS. The GPS coordinates may be according to the World Geodetic System, WGS 84, for example, version G1674 or a corresponding converted version. The trajectory data may be real world data, for example trajectory data recorded by vehicles, for example real world GPS data. Correspondently, the geographical area represents an area on Earth's surface. As used herein and in accordance with various embodiments, the terms ‘geographical’ and ‘geospatial’ may be used interchangeably. Trajectory data may be provided as a plurality of data points. According to various embodiments, the trajectory data may include one or more of: location, bearing, speed. Location may include one or more of longitude, latitude, altitude, for example longitude and latitude. Bearing may be obtained via calculations, for example, bearing may be calculated from two or more data points including longitude, latitude, and time. Alternatively, bearing may be determined by a vehicle's device, for example a compass, such as an electronic compass. Speed may be obtained via calculations, for example, speed may be calculated from two or more data points including longitude, latitude, and time. Alternatively, speed may be determined by a vehicle's device, for example, a speed sensor.

According to various embodiments, the method of predicting one or more road attributes may include extracting trajectory features from the trajectory data.

Trajectory features such as location, bearing, and speed may be extracted from trajectory data. For example, raw trajectory data may be provided, which may be originated from vehicles' tracking data (e.g. raw GPS data). Such extraction may be helpful since raw trajectory data (e.g., raw GPS traces) are noisy and do not contain the information of the road segments on which they were travelling.

According to various embodiments, extracting trajectory features from the trajectory data may include determining group of traces of the trajectory data that are associated with a road segment of the road segments. According to various embodiments, extracting trajectory features from the trajectory data may further include calculating a distribution of at least one of location, bearing, and speed, and using the distribution as the trajectory features.

A normalized histogram may be generated based on location as a trajectory feature. A normalized histogram may be generated based on bearing as a trajectory feature. A normalized histogram may be generated based on speed as a trajectory feature. Thus, as an example, 3 normalized histograms may be generated. In one example, Hidden Markov Model (HMM)-based map matching is performed on the trajectory data to find group of traces of the trajectory data that are associated with each road segment. The present disclosure is not limited to using histograms or HMM, for extracting trajectory features.

In one example, formally, let R={r₁, r₂, . . . , rₙ} denote a set of road segments, and Pⁱⱼ={Pⁱ₁, Pⁱ₂, . . . , Pⁱₘ} denote the set of trajectory data points associated with road segment rᵢ where Pⁱⱼ=(latⁱⱼ, lonⁱⱼ, bearingⁱⱼ, speedⁱⱼ) is a 4-tuple that contains the readings of latitude, longitude, bearing, and speed. Based on Pᵢ, the following three types of trajectory features for each road segment rᵢ from location, bearing, and speed, respectively, may be extracted. Examples for each feature extraction is given below, however the disclosure is not limited thereto, and other features may also be used.

A non-limiting example of location extraction is described here below. For each location (latⁱⱼ, lonⁱⱼ)∈Pᵢ, the great circle distance between point (latⁱⱼ, lonⁱⱼ) and road segment rᵢ may be computed. The distance may be mapped into bins, for example a distance of 100 meters may be mapped into 50 bins with each bin representing an interval of 2 meters. As the distance is continuous in space, binning allows the distance to be used as a feature. The number of locations that fall into each bin may be counted and the histogram of the count may be normalized, for example using the L1 norm. The normalized histogram may be used as location feature (E_{L}) included in the trajectory features.

A non-limiting example of bearing extraction is described here below. For each bearing bearingⁱⱼ∈Pᵢ, the angular distance between the moving direction of the vehicle and the direction of the road segment rᵢ may be computed. For example the 360° angular space may be quantized, for example into 36 or more bins, such as 36 bins with each bin representing an interval of 10°. A pre-determined diameter may be used, for example selected between 20 meters and 200 meters, such as 100 meter. Similarly, the number of bearings that fall into each bin may be counted and the histogram of the count may be normalized, for example, using the L1 norm. The normalized histogram may be used as a bearing feature (E_{b}) included in the trajectory features.

A non-limiting example of speed extraction is described here below. The speed may be quantized into slots where each slot denotes a speed interval, for example the speed interval may be selected from the range of 1 m/s to 20 m/s, such as 5 m/s or 10 m/s. A histogram may be generated by counting the number of speeds that fall into each slot. The histogram may be normalized, for example, using the L1 norm. The normalized histogram may be used as a speed feature (Eₛ) included in the trajectory features.

### Extracting Map Features

The method of predicting one or more road attributes may include a step of providing map data.

According to various embodiments, the map data may be in the form of image data, for example in electronic form configured to be stored in electronic digital format. An example of an electronic digital format for image data is JPEG.

According to various embodiments, the image data may be, or be obtained from, digital maps, for example existing digital maps. Example of existing digital maps are the maps provided from OpenStreetMap® (www.openstreetmap.org). The digital maps may include rules for the visualization of the geographic objects, for example including one or more of roads, highways, buildings. For example, each of the geographical objects and/or each attribute of the geographical objects, may have a different color, a different perimeter line style (e.g. a different line thickness), a different fill pattern, or a combination thereof. A combination of digital maps of different sources, e.g. having different rules of visualization, may also be used as source for the image data.

The image data 122 may include channels of different color, for example red (R), green (G), and blue (B).

According to various embodiments, the method of predicting one or more road attributes may include extracting map features from the map data, for example by generating cropped images. For example, wherein each of the cropped images is centered at one of the road segments. A cropped image may be generated for each road segment of the roads of the geographic area. The cropped image is considered as a visual feature, denoted as E^{v}, which captures the contextual information around a road for road attribute prediction. The use of image data and extraction of map features may provide advantages over using key-value pair representations of certain maps (e.g., node-id=26782044, oneway=True), especially when the representation is inconsistent with lots of missing values among different geographic objects.

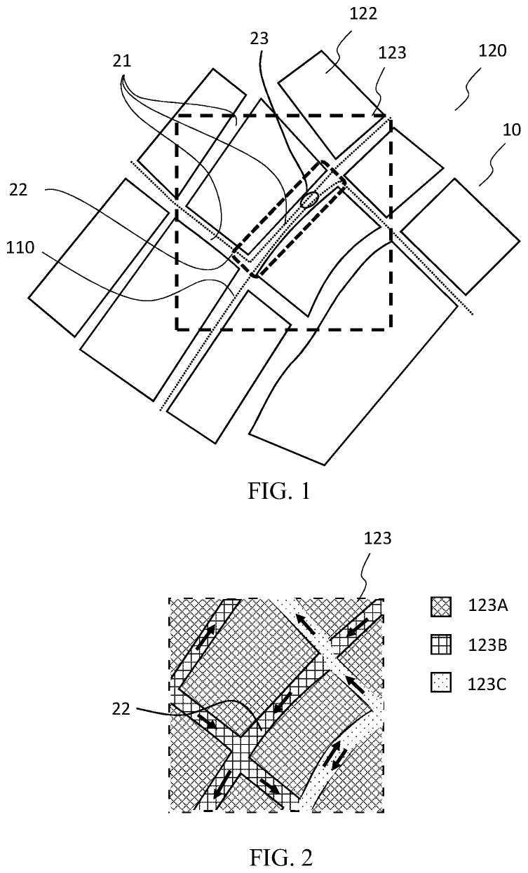

FIG. 1 shows a partial representation of a geographical area 10 including map data 120 in the form of image data 122. In the representation, trajectory data 110 is overlaid on the image of image data 122. The trajectory data is represented in the form of traces, while speed and bearing are not shown in FIG. 1 for simplicity. The geographical area includes several road segments 21, for example road segment 22. The traces may be grouped by road segment, for example road segment 22 is shown as having corresponding group of traces 23. The grouped traces may be used to extract the trajectory features.

A cropped image 123 may be provided by cropping images from the image data 122. Each cropped image 123 may correspond to a road segment of the road segments 21. For example the cropped image 123 may be centered at a corresponding road segment 22 of the road segments 21. The cropped image 123 may be used as a map feature. The map data 120 is independent from the trajectory data 110, which is shown overlaid in FIG. 1 for ease of understanding.

More details of a cropped image 123 are shown in FIG. 2, for illustration purposes. The cropped image 123 is shown in black and white wherein the contextual information is encoded in the different patterns, different line styles, and arrow direction. However, typical maps may include color, and the contextual information may, alternatively or in addition, be encoded in colors, e.g., in different RGB color channels. FIG. 2 shows roads, including main roads 123B (straight grid pattern), and motorways 123C (dotted pattern). The area 123A between the roads, for example, residential blocks, is shown with an angled cross hatching. Also shown on the road segments, are the directions for each road, for example, a single arrow on a road segment may indicate that the road is a one-way road and further indicates the direction of the one way road, and two arrows on a road segment may indicate that the road is a two-way road. Each of the arrows may indicate a direction in relation to Earth's true north.

The extracted trajectory and map features may be input on a neural network which output may be classified into prediction probabilities of road attribute classes. According to various embodiments, at least one processor may be used to predict road attributes by inputting the trajectory features and the map features in a neural network and by classifying an output of the neural network into prediction probabilities of the road attributes.

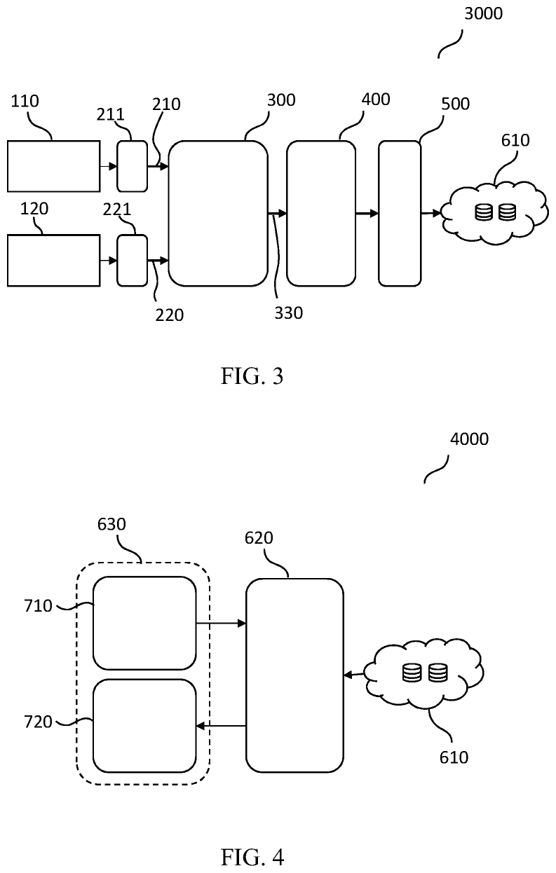

FIG. 3 shows a schematic representation of a data processing system 3000 configured to provide data extraction, neural network processing by a neural network 300, and classification by a classifier 400, for generating prediction probabilities 500. The data processing system may include at least one processor, for example, a microprocessor.

Illustrated in FIG. 3, is the provision of trajectory data 110 which may be processed by a trajectory feature extractor 211 configured to extract the trajectory features 210. Further shown, is the provision of map data 120 which may be processed by a map feature extractor 221 configured to extract the map features 220 (e.g. cropped image 123 of FIG. 2). A neural network 300 may receive the trajectory features 210 and the map features 220 as input and to generate task-specific fused representations 330. The output of the neural network 300 may then be classified by a classifier 400. Classifier 400 is configured to calculate one or more of the prediction probabilities 500 based on the task-specific fused representations 330.

According to various embodiments, the prediction probabilities 500 may be added to a map or used to update a map. For example, the map may be a digital map stored in a map database 610.

According to various embodiments, road attributes may include one or more of: one-way or two-way, number of lanes, direction for each lane, speed limit for each available direction, average speed for each available direction, road type. Predicting a road attribute may also be named as a task. Examples of road types are motorway (also known as highway), main road, street.

According to various embodiments, the predicted road attributes, for example, stored in the map database 610, may be used in routing decisions, for example in calculating the routing of a vehicle from an origin to a destination. FIG. 4 shows a schematic representation of an exemplary routing request and decision system 4000, in accordance with various embodiments. A front-end 630, may receive a vehicle routing request 710 including an origin A to, destination B, and a time t, for example sent via an electronic terminal (e.g. a digital device such as a mobile phone) by a user. The time t may be, e.g., a departure time or an arrival time. The vehicle routing request 710, or a request formed based on the vehicle routing request 710, may be send to a back-end 620, for example a back end server. The back-end 620 may access the map database 610 for determining a feasible, e.g., an optimized, route for a vehicle from the origin A to the destination B at the time t. Since the map database 610 includes the predicted road attributes for the geographic region comprising A and B, the determined route is optimized, it is more likely that the routing does not have a wrong routing decision, for example due to a missing road attribute in the map database 610. Furthermore, a predicted time of arrival, which may be determined by the back-end 610, may be more accurate.

The determined route 720 may be provided to the front-end, and may also be provided to the user if requested.

### Neural Network

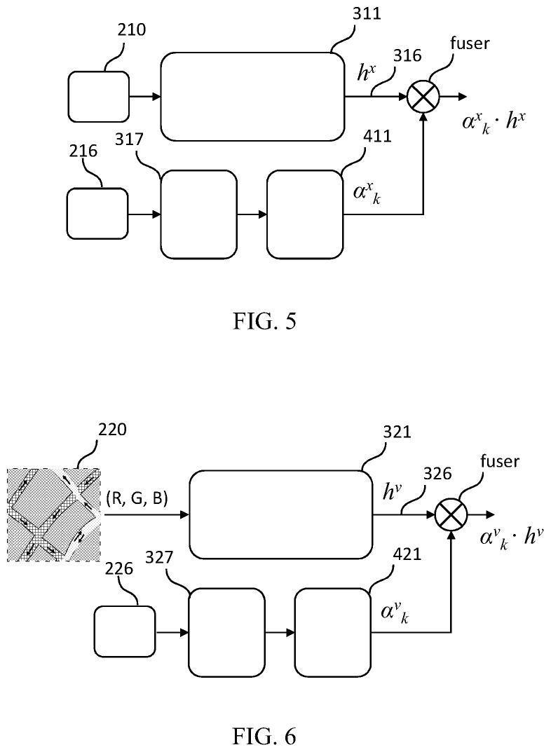

According to various embodiments, the neural network may be configured to receive the trajectory features and the map features and to generate task-specific fused representations. Details of an exemplary neural network, in accordance with various embodiments, will be explained in connection with FIGS. 5 and 6. In the drawings, a circle having two diameters crossing in “X” (⊗) represents a fuser, i.e., a unit that fuses input features into a fused output feature.

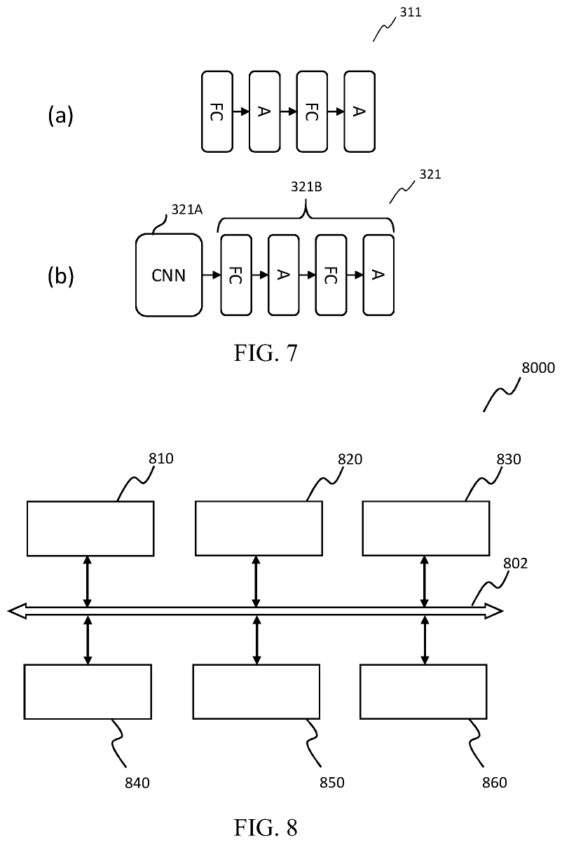

Multi-task learning is effective by jointly analyzing multiple tasks that are related to each other. In the present disclosure, shared weight feature embedding layers are adopted to learn common patterns in the feature space among multiple tasks. FIG. 5 illustrates the sub-networks for feature embedding of the trajectory features (first sub-neural network 311) and attention prediction (fully connected layer 317 and the activation function layer 411). FIG. 6 illustrates the sub-networks for feature embedding of the map features (second sub-neural network 311) and attention prediction (fully connected layer 327 and the activation function layer 421). Details of the first and second sub-neural networks will be shown further below, in connection with FIG. 7.

FIGS. 5 and 6 show details of the neural network. FIG. 5 shows a schematic representation of a portion of the neural network 300, including a first sub-neural network 311 which outputs shared global trajectory features 316 which are fused with corresponding attention scores α^{x}. The first sub-neural network 311 may also be named as trajectory data neural network.

According to various embodiments, the trajectory features 210 may be processed by the first sub-neural network 311 into shared global trajectory features 316 (h^{x}), wherein the first sub-neural network 311 may include one or more fully-connected layers 312, 314. This processing provides the trajectory features embedding. The superscript x may be any of the trajectory features, for example location (L), bearing (b), or speed (s).

According to various embodiments, the method of predicting one or more road attributes may include determining attention scores (α^{x}ₖ) of pre-defined indicators 216 corresponding to road attributes 20 based on the trajectory data 110. The pre-defined indicators 216 may be processed by a fully connected layer 317. The attention scores α^{x} may be determined based on activation functions, for example, by processing the output of the fully connected layer 317 with an activation function layer. In one example, the activation function is a sigmoid.

According to various embodiments, the trajectory task-specific weighted representations 330 (α^{x}ₖ·h^{x}) are calculated based on the fusion of the attention scores (α^{x}ₖ) with the shared global trajectory features (h^{x}) of the first sub-neural network 311.

FIG. 6 shows a schematic representation of a portion of the neural network 300, including a second sub-neural network 321 which outputs shared global map features 326 (h^{v}) which are fused with respective attention scores ay. The second sub-neural network 311 may also be named as map data neural network.

According to various embodiments, the map features 220 may be processed by a second sub-neural network 321 into shared global map features 326 (h^{v}). This processing provides the map features embedding.

According to various embodiments, the method of predicting one or more road attributes may include determining attention scores (α^{v}ₖ) of pre-defined indicators 226 corresponding to road attributes 20 based on the map data 120. According to various embodiments, the pre-defined indicators 226 may be processed by a fully connected layer 327. The attention scores α^{v} may be determined based on activation functions, for example, by processing the output of the fully connected layer 327 with an activation function layer. In one example, the activation function is a sigmoid.

According to various embodiments, the map task-specific weighted representations 330 (α^{v}ₖ·h^{v}) are calculated based on the fusion of the attention scores α^{v} (α^{v}ₖ) with the shared global map features 326 (h) of the second sub-neural network 321.

### Attention Prediction

As explained above, and in accordance with various embodiments, the method may include providing pre-defined indicators 216, 226 and process these by a respective fully connected layer 317, 327, thereby predicting the importance of each feature, e.g., the trajectory features 210, and the map features 220. The importance prediction is provided by the respective attention scores.

The features may be fused based on their importance, which provides advantages over simply concatenating them together, as it was found out that the importance of the different features vary significantly among different tasks.

In some embodiments, the feature importance may be predicted based on the one-hot representation that indicates the feature type. For example, the indicators I^{L}=[1, 0, 0, 0], I^{b}=[0, 1, 0, 0], I^{s}=[0, 0, 1, 0], and I^{v}=[0, 0, 0, 1] may be used to denote the one-hot indicators for the four types of features, location (L), bearing (b), speed (s), and map data (v) respectively. However, the disclosure is not limited to this example. The indicators may be processed by the fully-connected layer and the activation function layer (e.g., using a sigmoid activation) to generate the feature attention scores α^{x}, and 421 which are task-specific. For example, the location embedding may be more important to derive the number of lanes; the speed embedding may be more important for the speed limit and/or and average speed prediction, the bearing may be more important to one-way or two-way road prediction. According to various embodiments, the number of hidden units in the fully-connected layer may equal to the number of target tasks. An activation function may be used, for example, the sigmoid activation, to ensure the attention scores are in the range of [0, 1].

According to various embodiments, the fusion may be carried out as a product of the attention scores (αₖ) with their respective shared global features (h) providing task-specific weighted representations (αₖ·h), which may be concatenated therefore providing the task-specific fused representation (hₖ).

Let α^{L}ₖ, α^{b}ₖ, α^{s}ₖ, and α^{v}ₖ (represent the attention scores (importance) of features E^{L}, E^{b}, E^{s}, and E^{v} in task k. The multimodal features may be fused, for example, as:

hₖ=αₖ^{l}·h^{l}+αₖ^{b}·h^{b}+αₖ^{s}·h^{s}+αₖ^{v}·h^{v}

where a+b represents the concatenation of two vectors a and b.

Though the shared-weight embedding layers generate shared global feature embeddings among different tasks, it is still possible to learn task-specific fused representations hₖ based on task-specific attention scores. It was found out that the importance of the different features vary significantly among different tasks. For example, bearing is closely related to one- or two-way direction, but is less correlated to the number of road-lanes. The strategy of learning task-specific fused representations based on task-specific attention scores is more effective than feature concatenation with equal weights where the same fused representation is generated among different tasks.

According to various embodiments, the first sub-neural network may include one or more fully connected layers FC. Each of the fully connected layers FC may be followed by an activation layer, for example a Rectified Linear Unit (ReLu) for ReLu activation.

Shown in the example of FIG. 7 (a), is a schematic representation of the architecture of the first sub-neural network 311, including a sequence of two fully connected layers FC layers, each followed by an activation layer A. In one example, each of the fully connected layers FC includes 32 hidden units. The first sub-neural network 311 may use the extracted vehicle trajectory features to process the initial embeddings E^{L}, E^{b}, E^{s}.

According to various embodiments, the cropped images (map features) cropped from the map, may be processed by a second sub-neural network. The second sub-neural network may include a convolutional neural network CNN followed by one or more fully connected layers FC. The convolutional neural network CNN may be a 2D convolutional neural network CNN. Each of the fully connected layers FC may be followed by an activation layer, for example a Rectified Linear Unit (ReLu) for ReLu activation.

Shown in the example of FIG. 7 (a), is a schematic representation of the architecture of the second sub-neural network 321, including a convolutional neural network CNN 321A followed by a sequence of two fully connected layers FC, each followed by an activation layer A. Portion 321B of the two fully connected layers FC, each followed by an activation layer A, may have an identical structure as the first sub-network 311, for example a same number of hidden units per fully connected layer FC layer, and/or a same activation function in layer A. In the example, the raw images E^{v} may be processed by a 2D CNN 321A with three convolutional layers. A kernel size of 3 may be adopted and the number of filters may be set to 32, 64, and 128, respectively. A 3×3 max pooling may be applied after each convolutional layer and the output of the CNN may be passed to the two fully-connected layers with 32 hidden units FC followed by the ReLU activations A.

According to some embodiments, the classifier may include a group of task-specific classifiers. Each task-specific classifier may be configured to output the prediction of one of the road attributes. The output feature vectors of the embedding layers, denoted as h^{L}, h^{b}, h^{s}, and h^{v}, may then be fused based on task-specific attention scores as explained above, and analyzed by the task-specific classifiers. For example, for training, explained further below, the overall loss may be defined as the sum of the losses of all the classifiers, so the task-specific classifiers can be trained together.

### Classifier

According to various embodiments, the classifier may be configured to calculate one or more of the prediction probabilities based on the task-specific fused representations. For example, for each task k, a prediction may be made based on the fused feature hₖ by passing it to fully connected layers and an output layer. For example, two fully connected layers with 16 and 8 hidden units followed by activation (e.g. ReLU activation), and one output layer.

### Training

Various embodiments may related to a method for training an automated predictor, and the trained automated predictor trained by said method. The automated predictor may include the neural network and the classifier. The neural network and the classifier are trained together. The automated predictor may be implemented in a data processing system in accordance with various embodiments. The trained predictor may be used for carrying out the method of predicting one or more road attributes, in accordance with various embodiments.

The method for training may include performing forward propagation by inputting training data into the automated predictor to obtain an output result, for a plurality of road segments of a geographical area. The training data may include trajectory features, map features having an electronic image format, and the corresponding ground truth road attributes.

The method for training may further include performing back propagation based on a difference between the output result and an expected result to adjust weights of the automated predictor, such as the weights of the neural network and the classifier. The weights of the neural network may include one or more, preferably all, of the weights of the first and second sub-neural networks, of the CNN, and of the fully connected layers. This difference may be determined with a loss function. An optimizer may also be implemented to improve the training speed.

The method for training may further include repeating the above steps, e.g., of forward propagation and back propagation, until a pre-determined convergence threshold may be achieved.

To reduce overfitting, a dropout layer may be added after each fully-connected layer of the automated predictor, e.g., of the neural network and the classifier. In one example, the drop rate may be set to 0.3. The prediction of each road attribute may be modelled as a multi-class classification problem, wherein the category cross entropy may be adopted as the loss function. Let Lₖ denote the loss for task k, the final loss may be defined to be,

$$L = {\sum }_{k} {β}_{k} \cdot {L}_{k}$$

where βₖ is in the range of [0, 1], representing the weight of the loss for task k. The automated predictor may be optimized, for example using the Adam optimizer with batch size set to 1024. The learning rate may be set to 0.001.

The automated predictor may include a neural network configured to predict road attributes based on trajectory features and map features. The automated predictor may further include a classifier configured to classify an output of the neural network into prediction probabilities of the road attributes.

Various embodiments may related to a trained automated predictor, including a trained neural network and a trained classifier.

### Computer Program Product

Various embodiments may relate to a computer executable code and/or to a non-transitory computer-readable medium storing the computer executable code including instructions for extracting road attributes according to the method of predicting one or more road attributes in accordance with various embodiments. For example, the computer executable code may be executed in a computer 8000 as illustrated in FIG. 8.

According to various embodiments, a data processing system may include one or more processors configured to carry out the method of predicting road attributes 20. The data processing system may be implemented in a computer, for example the computer 8000 shown in FIG. 8. The data processing system may include a first memory configured to store trajectory data 110 of the geographical area 10. For example, the trajectory data may be obtained from a server via a JavaScript Object Notation (JSON) request. The processing system may include a second memory configured to store map data 120, wherein the map data 120 may include image data 122 of the geographical area. For example, the map data 120 may be stored in a server providing local and/or global digital maps, e.g., which may be accessed by a location. The processing system may include a trajectory feature extractor 211 configured to extract trajectory features 210 from the trajectory data 110, in accordance with various embodiments. The processing system may include a map feature extractor 221 configured to extract map features 220 from the map data 120. For example, the map feature extractor may crop map images to a pre-determined required size and/or for a pre-determined location (e.g. centered at a road segment). The processing system may include a neural network 300 configured to predict road attributes 20 based on trajectory features 210 and map features 220, in accordance with various embodiments. The processing system may include a classifier 400 configured to classify an output of the neural network 300 into prediction probabilities 500 of the road attributes 20.

FIG. 8 shows the architecture of an exemplary computer 8000, which may be used in accordance with various embodiments. The computer 8000 includes a bus 810 through which one or more of the devices may communicate with each other. In the example of FIG. 10, the following devices are shown connected to the bus 800: a CPU 801; a main memory 802, for example a RAM; a storage device 803, for example a hard disk drive, a solid state drive, a flash drive; a communication device 804, for example for wired or wireless communication, e.g. WiFi, USB, Bluetooth; a display interface 805, and other user interfaces 806, for example for user input; however the disclosure is not limited thereto, and more or less devices may be included in the computer and the computer and/or bus may have other architectures than the one illustrated.

### Experiments

Features were extracted as previously explained, with details given in the following. Location extraction: for each location (latⁱⱼ, lonⁱⱼ)∈Pᵢ, the great circle distance between point (latⁱⱼ, lonⁱⱼ) and road segment rᵢ was computed. A distance of 100 meters was mapped into 50 bins with each bin representing an interval of 2 meters. The number of locations that fall into each bin was counted and the histogram of the count was normalized using the L1 norm. The normalized histogram was used as location feature (E_{L}) included in the trajectory features. Bearing extraction: for each bearing bearingⁱⱼ∈Pᵢ, the angular distance between the moving direction of the vehicle and the direction of the road segment rᵢ was computed. The 360° angular space was quantized into 36, with each bin representing an interval of 10°. A pre-determined diameter of 100 meter was used. The number of bearings that fall into each bin was counted and the histogram of the count may be normalized using the L1 norm. The normalized histogram was used as the bearing feature (E_{b}). Speed extraction: the speed was quantized into slots where each slot denotes a speed interval of 10 m/s. A histogram was generated by counting the number of speeds that fall into each slot. The histogram was normalized using the L1 norm and used as a speed feature (Eₛ) included in the trajectory features.

The neural network and the classifier had the following configuration: each of the fully connected layers FC includes 32 hidden units. The CNN is a 2D CNN with 3 convolutional layers. A kernel size of 3 was adopted and the number of filters was set to 32, 64, and 128, respectively. A 3×3 max pooling was applied after each convolutional layer and the output of the CNN was passed to the two fully-connected layers with 32 hidden units FC followed by the ReLU activations A. For training, the automated predictor, which includes the neural network and the classifier, was trained as previously explained.

Experiments were conducted for three different areas in Singapore. The map data in these areas were retrieved from OpenStreetMap using a python library named OSMnx. For the experiments, 3 road attributes are targeted, namely one-way/two-way road, number of lanes, and speed limit, and the ground-truth labels were derived from OSM data. The road segments without ground-truth labels were removed and data for the remaining road segments were split into 80%-20% splits for training and testing, respectively. The number of training and testing samples in each task (road attribute) is illustrated in Table 1 below.

TABLE 1
Number of samples in the training/testing datasets for the 3 road attributes

| Dataset | One/Two Way | No. of Lanes | Speed Limit |
|---|---|---|---|
| Area 1 | 1557/390 | 991/250 | 405/103 |
| Area 2 | 2146/537 | 1501/379 | 389/101 |
| Area 3 | 1205/302 | 848/217 | 328/84 |
| Areas 1 & 2 & 3 | 4908/1229 | 3340/846 | 1122/288 |

As can be seen, only about 68% and 23% of the roads are labelled with road-lane numbers and speed limit, which again indicates the importance of automatic algorithms on missing road attribute detection. For feature extraction, the GPS trajectories of in-transit Grab drivers in Singapore were used and the map tiles (cropped images) retrieved as described above.

The following methods are compared and the classification accuracy is reported in Table 2, below.

In a first comparative example (SinFea) a neural network is trained for each road attribute separately based on a single feature only. SinFea uses the most relevant feature extracted from GPS traces. In a second comparative example (SinFea-M) the image extracted from map data is used.

In a third comparative example (AttMTL), the relations between the road attributes is modelled, using a multi-task learning framework to jointly detect multiple road attributes based on GPS features fused by attention scores. AttMTL was configured similarly to the embodiments of the present disclosure, however without using map information (or any other image information).

Represents results of examples (AttMTL-M) according to the present disclosure. The relations between road attributes and contextual information in existing maps is modelled, an image is cropped at each road center and fused with features extracted from GPS traces in our proposed multi-task learning framework with attention-based feature fusion.

TABLE 2
(a) Area 1

| Method | One/Two Way | No. of Lanes | Speed Limit |
|---|---|---|---|
| SinFea | 0.8846 | 0.4240 | 0.6506 |
| SinFea-M | 0.7205 | 0.4040 | 0.7864 |
| AttMTL | 0.9051 | 0.4640 | 0.7476 |
| AttMTL-M | 0.9154 | 0.5440 | 0.9029 |

TABLE 2
(b) Area 2

| Method | One/Two Way | No. of Lanes | Speed Limit |
|---|---|---|---|
| SinFea | 0.8473 | 0.4987 | 0.7228 |
| SinFea-M | 0.7505 | 0.4802 | 0.8317 |
| AttMTL | 0.8827 | 0.6544 | 0.8218 |
| AttMTL-M | 0.9032 | 0.7177 | 0.8911 |

TABLE 2
(c) Area 3

| Method | One/Two Way | No. of Lanes | Speed Limit |
|---|---|---|---|
| SinFea | 0.9139 | 0.5069 | 0.7143 |
| SinFea-M | 0.7483 | 0.4793 | 0.7976 |
| AttMTL | 0.9205 | 0.5899 | 0.7738 |
| AttMTL-M | 0.9205 | 0.6728 | 0.8690 |

TABLE 2
(d) Areas 1 & 2 & 3

| Method | One/Two Way | No. of Lanes | Speed Limit |
|---|---|---|---|
| SinFea | 0.8804 | 0.5319 | 0.6285 |
| SinFea-M | 0.7469 | 0.4965 | 0.8160 |
| AttMTL | 0.9105 | 0.6052 | 0.7812 |
| AttMTL-M | 0.9211 | 0.6702 | 0.9028 |

The SinFea method trained a classifier based on a single, most relevant GPS feature for each task, i.e., bearing for one/two way detection, location for number of lanes detection, and speed for speed limit detection. The SinFea-M method trained the classifiers using the image tiles extracted from map data. The results show that the former is more effective for one/two way and number of lanes detection, while the latter is more effective for speed limit detection. This is related to the default map visualization for incomplete map data with missing key-value pairs.

The results of method AttMTL reported in Table 2 were obtained by assigning equal weights to the three tasks. On one hand, the shared-weight embedding layers in AttMTL learn global low-level features that are shared among multiple tasks. On the other hand, the attention-based fusion layers in AttMTL combine shared low-level features into task-specific fused representations for the prediction of each task. This strategy has been shown to be effective, especially on small to moderate datasets, with the following two advantages. First, it indicates that connections exist among different road attributes, thus improved classification results can be obtained by modelling the connections by multi-task learning. Second, it increases both the quantity and the diversity of training samples (especially for speed limit) as samples that are labelled with any one of the road attributes can be utilized to learn the shared low-level features among tasks. Finally, in the AttMTL-M approach, features extracted from GPS traces and map data are analyzed jointly. As can be seen, the proposed method obtained the best road attribute detection accuracy among the shown methods. It outperformed AttMTL by 1.2%, 10.7%, and 15.6% for one/two way detection, number of lanes detection, and speed limit detection, respectively. The results thus demonstrate the effectiveness of the embodiments of the present disclosure.

Tables 3 and 4 report the per-class precision, recall, and F1 measure of methods AttMTL and AttMTL-M on number of lanes detection (classes of number of lanes 1 to 5) and speed limit detection (classes of number of speed limits 40 km/h to 90 km/h), respectively. The results of one class are computed as follows. For a class c (e.g., speed limit of 50 km/h), retrieved are all the samples with the predicted labels to be either c or the neighbouring classes of c (e.g., speed limit of 40 km/h and 60 km/h for class c=50 km/h). The recall of the retrieved samples for class c is computed and the results are reported in column one class. This metric measures the “distance” between the prediction and the ground-truth label. For example, a high +/−one class score for speed limit detection means that the predicted speed limit is close to the true speed limit of the road. Under such circumstances, the predicted road attributes can still be beneficial for downstream applications (routing) without introducing significant errors. The number of test samples for the five classes in the road-lane detection is 132, 408, 169, 91, and 37, while that for the six classes in the speed limit detection is 20, 88, 151, 7, 17, and 5, respectively. Due to the problem of class imbalance, it is more challenging to detect samples from the rare classes. “-” is used in the tables to represent that no instances from that class were detected and returned by the algorithm.

TABLE 3
Per-class precision, recall, and F1 measure comparison
on the road attribute of number of lanes

| | AttMTL | | | | AttMTL-M | | | |
|---|---|---|---|---|---|---|---|---|
| | | | | +/− one | | | | +/− one |
| Class | precision | recall | F1 | class | precision | recall | F1 | class |
| 1 | 0.7030 | 0.5379 | 0.6094 | 0.9697 | 0.6620 | 0.7121 | 0.6861 | 0.9470 |
| 2 | 0.7159 | 0.7966 | 0.7541 | 1.000 | 0.8430 | 0.7500 | 0.7938 | 0.9534 |
| 3 | 0.3986 | 0.6864 | 0.5043 | 0.9941 | 0.5775 | 0.6391 | 0.6067 | 0.9645 |
| 4 | — | — | — | 0.7912 | 0.3831 | 0.6484 | 0.4816 | 0.8791 |
| 5 | — | — | — | — | — | — | — | 0.8919 |

TABLE 4
Per-class precision, recall, and F1 measure comparison on
the road attribute of speed limit

| | AttMTL | | | | AttMTL-M | | | |
|---|---|---|---|---|---|---|---|---|
| | | | | +/− one | | | | +/− one |
| Class | precision | recall | F1 | class | precision | recall | F1 | class |
| 40 | 0.6316 | 0.6000 | 0.6154 | 1.0000 | 0.8235 | 0.7000 | 0.7568 | 1.0000 |
| 50 | 0.7284 | 0.6705 | 0.6982 | 1.0000 | 0.8587 | 0.8977 | 0.8778 | 1.0000 |
| 60 | 0.8354 | 0.9073 | 0.8698 | 1.0000 | 0.9351 | 0.9536 | 0.9443 | 1.0000 |
| 70 | — | — | — | 0.8571 | 1.0000 | 0.7143 | 0.8333 | 1.0000 |
| 80 | 0.7391 | 1.0000 | 0.8500 | 1.0000 | 0.8889 | 0.9412 | 0.9143 | 0.9412 |
| 90 | — | — | — | 0.6000 | 1.0000 | 0.4000 | 0.5714 | 0.6000 |

Generally speaking, method AttMTL-M is more robust as it outperformed method AttMTL in terms of the F1 measure in all classes. One advantage of method AttMTL-M is that it performed more effectively in detecting samples from rare classes. Method AttMTL, on the other hand, tended to label samples as one of the major class, resulting in obtaining relatively high recall and low precision compared to AttMTL-M in those classes. In terms of the +/−one class measure, both methods obtained high recalls among the classes especially method AttMTL-M where most of the recalls it obtained was greater than 90%. It indicates that in most of the cases, the predicted class returned by the herein proposed methods in accordance with various embodiments is either the true class or the neighbours of the true class. This measure can be an important indicator of the usability of the predicted road attributes in downstream applications, as it measures the level of errors introduced when annotating roads with the detected attributes.

Conventional road attribute detection methods extract intuitive hand-crafted features from GPS traces and model each road attribute separately. In contrast, the present disclosure presents a multi-task learning based model for road attribute detection via joint analysis of vehicle trajectory data and map data. Embodiments model the relations among the road attributes via multi-task learning, including feature embedding layers, attention-based feature fusion, and task-specific classification layers. The first component learns common patterns in the feature space among multiple tasks, which are next fused by the task-specific importance scores of the features computed in the second component. The third component predicts the attribute labels via task-specific classification layers, the losses of which are jointly minimized during training. Moreover, contextual features may be extracted from map data that contain the information of the geographic objects in the vicinity of a road, to facilitate the detection of missing road attributes.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method of predicting one or more road attributes corresponding to roads in a geographical area, the geographical area comprising road segments, the method comprising:
providing trajectory data of the geographical area;
providing map data, wherein the map data comprises image data of the geographical area;
extracting trajectory features from the trajectory data;
extracting map features from the map data; and
using at least one processor to predict road attributes by inputting the trajectory features and the map features in a neural network and by classifying an output of the neural network into prediction probabilities of the road attributes,
wherein the neural network comprises a first sub-neural network for the trajectory features and a second sub-neural network for the map features.

2. The method of claim 1, wherein the neural network is configured to receive the trajectory features and the map features and to generate task-specific fused representations, and
wherein classifying is executed by a classifier, the classifier being configured to calculate one or more of the prediction probabilities based on the task-specific fused representations.

3. The method of claim 1, wherein the trajectory features are processed by the first sub-neural network into shared global trajectory features, wherein the first sub-neural network comprises one or more fully-connected layers.

4. The method of claim 2, further comprising
determining attention scores of pre-defined indicators corresponding to road attributes based on the trajectory data, wherein the pre-defined indicators are processed by a fully connected layer, and wherein the attention scores are determined based on activation functions.

5. The method of claim 4, wherein trajectory task-specific weighted representations are calculated based on the fusion of the attention scores with the shared global trajectory features of the first sub-neural network.

6. The method of claim 1, wherein the map features are processed by the second sub-neural network into shared global map features.

7. The method of claim 6, further comprising calculating second attention scores of pre-defined indicators based on the shared global map features, wherein the pre-defined indicators are processed by a second fully connected layer, and wherein the second attention scores are determined based on activation functions.

8. The method of claim 7, wherein map task-specific weighted representations are calculated based on the fusion of the second attention scores with the shared global map features of the second sub-neural network.

9. The method of claim 5, wherein
the map features are processed by the second sub-neural network into shared global map features;
the method further comprises calculating second attention scores of pre-defined indicators based on the shared global map features, wherein the pre-defined indicators are processed by a second fully connected layer;
the second attention scores are determined based on activation functions, wherein map task-specific weighted representations are calculated based on the fusion of the second attention scores with the shared global map features of the second sub-neural network; and
task-specific fused representations are determined based on the map task-specific weighted representations and the trajectory task-specific weighted representations.

10. The method of claim 1, wherein extracting map features from the map data comprises generating cropped images by cropping images from the image data, wherein the cropped images are centered at a corresponding road segment of the road segments.

11. The method of claim 1, wherein extracting trajectory features from the trajectory data comprises determining group of traces of the trajectory data that are associated with a road segment of the road segments.

12. The method of claim 11, wherein extracting trajectory features from the trajectory data further comprises calculating respective distributions of one or more of location, bearing, and speed, and using the distributions as the trajectory features-.

13. The method of claim 1, wherein the trajectory data comprises a plurality of data points, each data point comprising latitude, longitude, bearing, and speed.

14. A data processing system comprising one or more processors configured to carry out predicting road attributes corresponding to roads in a geographical area, comprising:
a first memory configured to storing trajectory data of the geographical area;
a second memory configured to storing map data, wherein the map data comprises image data of the geographical area;
a trajectory feature extractor configured to extract trajectory features from the trajectory data;
a map feature extractor configured to extract map features from the map data;
a neural network configured to predict road attributes based on the trajectory features and the map features;
a classifier configured to classify an output of the neural network into prediction probabilities of the road attributes,
wherein the neural network comprises a first sub-neural network for the trajectory features and a second sub-neural network for the map features.

15. The data processing system of claim 14, wherein
the neural network is configured to receive the trajectory features and the map features and to generate task-specific fused representations, and
wherein the classifier is configured to calculate one or more of the prediction probabilities based on the task-specific fused representations.

16. The data processing system of claim 15, wherein the first sub-neural network is configured to process the trajectory features into shared global trajectory features, wherein the first sub-neural network comprises one or more fully-connected layers.

17. The data processing system of claim 15, wherein the neural network further comprises a fully connected layer and wherein the neural network is further configured to determine attention scores of pre-defined indicators corresponding to road attributes based on the trajectory data, wherein the pre-defined indicators are processed by the fully connected layer, and wherein the attention scores are determined based on activation functions.

18. The data processing system of claim 17, wherein the first sub-neural network is configured to process the trajectory features into shared global trajectory features, wherein the first sub-neural network comprises one or more fully-connected layers.

19. The data processing system of claim 18, wherein the neural network is configured to fuse the attention scores with the shared global trajectory features of the first sub-neural network thereby generating trajectory task-specific weighted representations.

20. (canceled)

21. (canceled)

22. (canceled)

23. (canceled)

24. (canceled)

25. (canceled)

26. A method for training an automated predictor, the method comprising:
performing forward propagation by inputting training data into the automated predictor to obtain an output result, for a plurality of road segments of a geographical area, wherein the training data comprises:
trajectory features;
map features having an electronic image format;
performing back propagation according to a difference between the output result and an expected result to adjust weights of the automated predictor; and
repeating the above steps until a pre-determined convergence threshold is achieved, wherein the automated predictor comprises:
a neural network configured to predict road attributes based on trajectory features and map features; and
a classifier configured to classify an output of the neural network into prediction probabilities of the road attributes,
wherein the neural network comprises a first sub-neural network for the trajectory features and a second sub-neural network for the map features.

27. (canceled)
